(19) United States
(12) Patent Application Publication
(10) Pub. No.: US 2011/0069683 A1
(43) Pub. Date: Mar. 24, 2011

(54) ALLOCATION METHOD AND BASE STATION APPARATUS USING THE SAME

(75) Inventor: Tadahisa Kohyama, Gifu (JP)

(73) Assignee: KYOCERA CORPORATION, Kyoto (JP)

(21) Appl. No.: 12/934,564

(22) PCT Filed: Mar. 27, 2009
(86) PCT No.: PCT/JP2009/056396

§ 371 Date: Dec. 6, 2010

(30) Foreign Application Priority Data
Mar. 27, 2008 (JP) 2008-084904

(51) Int. Cl. H04J 3/00

(52) U.S. Cl. 370/336

(57) ABSTRACT

One object of the present invention is to prevent deterioration of communication quality and perform handover while maintaining a stable communication state. The terminal detection unit classifies a terminal device 20 into a predetermined moving object group based on determination factors. The time slot specifying unit 1051 associates a moving object group to a time slot and specifies the associated time slot for the terminal device 20 of the moving object group. The channel allocation unit 1052 allocates a sub-channel block included in the time slot specified by the time slot specifying unit 1051 to the terminal device 20 of the moving object group.

### TECHNICAL FIELD

The present invention relates to an allocation technique of a time slot, in particular, to a method of allocating a time slot to a terminal device in a moving object and a base station apparatus using the method.

### BACKGROUND ART

Using a wireless communication system in a moving object, such as a train, which moves at a high speed, has been widely available. In a wireless communication system, a base station apparatus is provided in each wireless zone, and a terminal device performs communication with the base station apparatus of the wireless zone. Accordingly, if a moving object traverses a wireless zone, a terminal device in the moving object is disconnected from the communication with the base station apparatus. In order to enable communication even in this situation, if the moving object moves into another wireless zone, the terminal device in the moving object perform handover to switch the connection from the base station apparatus in the wireless zone of the movement origin to a base station apparatus in a wireless zone of a movement destination (for example, refer to JP-A-2000-229571).

### DISCLOSURE OF THE INVENTION

### Problems to be Solved by the Invention

In handover, it is required to stably switch connection so as to avoid disconnection of communication between a base station and a terminal device. In a recent wireless communication system, in order to realize large amount of data transmission, a plurality of terminal devices are frequency multiplexed. Therefore, time required for ranging process in handover could increase depending on an allocation method of time slots, which would cause deterioration in communication quality and unstable communication state at a connection switching.

The present invention has been made in view of the above circumstances, and one object is to provide an allocation method of a time slot and a base station apparatus using the method which can perform handover while maintaining a stable communication state.

### Means to Solve the Problem

An aspect of the present invention provides a base station apparatus. The base station apparatus includes a detection unit which detects a terminal device existing in a moving object, and an allocation unit which, if the detection unit detects a plurality of terminal devices in the moving object, allocates a sub-channel being frequency-multiplexed in a certain time slot, to the plurality of the terminal devices.

It is preferable that the allocation unit specifies a time slot for each of a plurality of moving objects, and allocates, to a plurality of terminal devices existing in a same moving object, sub-channels included in the time slot specified for the moving object.

It is preferable that the base station apparatus further includes a search unit which searches a use status of time slots in another base station apparatus, and a performing unit which performs a handover process with a plurality of terminal devices existing in a same moving object, and when allocating sub-channels to the plurality of terminal devices in the handover process, the performing unit controls the allocation unit to specify a time slot, which is less used in a handover originating base station apparatus, for the plurality of terminal devices, based on the use status searched by the search unit.

It is preferable that in order to detect a terminal device existing in a moving object, the detection unit uses a relative distance to the terminal device, a movement speed of the terminal device, and a movement direction of the terminal device, as determination factors.

It is preferable that the detection unit sets a priority to the relative distance to the terminal device, the movement speed of the terminal device, and the movement direction of the terminal device, in this order, and detects the terminal device with reference to the determination factors based on the priority.

It is preferable that if the movement speed of the terminal device is smaller than a predetermined threshold value, the detection unit does not perform the detection.

It is preferable that in order to detect a terminal device existing in a moving object, the detection unit uses a location of the terminal device as a determination factor.

Another aspect of the present invention provides a base station apparatus. The base station apparatus includes an acquisition unit which acquires information, the information being based on locations of a plurality of terminal devices, a group forming unit which forms a moving object group including a plurality of terminal devices based on the acquired information, and an allocation unit which allocates a plurality of sub-channel being frequency multiplexed in a certain time slot to the plurality of terminal devices belonging to the moving object group.

The base station apparatus may further include a storing unit which stores a table for associating a moving object group formed in the group forming unit and a time slot, and the allocation unit may allocate a plurality of sub-channels in the time slot associated with the moving object group in the table.

The group forming unit may form a plurality of moving object groups, and the table may associate different time slots to the plurality of moving object groups, respectively.

The moving object group may be associated with a property value related to a terminal device belonging to the moving object group, and if the acquisition unit acquires information based on a location of a terminal device, the group forming unit may compare the acquired information with the property value to determine whether the corresponding terminal device is to belong to the moving object group.

The property value may be obtained based on the information acquired by the acquisition unit, the information being based on locations of the plurality of terminal devices belonging to the moving object group.

The information based on the locations may include a relative distance of the terminal device to the base station apparatus, a movement speed of the terminal device, and a movement direction of the terminal device.

### EFFECTS OF THE INVENTION

According to the present invention, deterioration of communication quality can be reduced, and handover can be performed while maintaining a stable communication state.

### BRIEF DESCRIPTION OF DRAWINGS

FIG. 1 is a concept view showing the configuration of a moving object communication system according to an embodiment of the present invention.

FIG. 2 is a concept view showing the configuration of a TDMA frame.

FIG. 3 is a concept view showing time slots which are frequency multiplexed in accordance with OFDMA.

FIG. 4 is a concept view showing the configuration of a sub-channel block.

FIG. 5 is a concept view showing the configuration of a base station apparatus according to an embodiment of the present invention.

FIG. 6 is a concept view showing a data structure of a table for associating a moving object group and a time slot.

FIG. 7 is a sequence view showing a handover procedure.

FIG. 8 is a sequence view showing a connection procedure to establish a communication channel.

FIG. 9 is a flow chart showing the procedure of classification into moving object groups.

FIG. 10 is a flow chart showing the procedure of specifying a time slot.

### DESCRIPTION OF REFERENCE NUMERALS

101: Wireless unit
102: Transmitting and receiving unit
103: Modulation and demodulation unit
104: IF unit
105: Control unit
1050: Terminal detection unit
1051: Time slot specifying unit
1052: Channel allocation unit
1053: Handover processing unit
1054: Recording unit

### BEST MODE FOR CARRYING OUT THE INVENTION

The concept of the present invention is described below prior to the detailed description thereof. An embodiment of the present invention relates to a moving object communication system, which is configured by PAC (Paging Area Controller), a plurality of base station apparatuses, and a terminal device, like a second-generation codeless telephone system. One of the PAC is connected to the plurality of base station apparatuses, and the other end thereof is connected to a network. Each of the plurality of base station apparatuses configures a wireless zone and is connected to a terminal device in the wireless zone. If the terminal device moves from one wireless zone to another wireless zone, the terminal device performs handover from the base station apparatus of the movement origin to a base station apparatus of a movement destination.

In the handover, the terminal device disconnects the connection to the base station apparatus of the movement original and performs process to establish connection to a base station apparatus of a movement destination. In addition, the terminal device also performs a ranging process to adjust transmission power of a signal or the like between the terminal device and the base station apparatus of the movement destination. In the ranging process, the base station apparatus detects a differential amount from an ideal value of receiving power for a message transmitted from the terminal device. And, based on the differential amount, the base station apparatus calculates a correction amount to control transmission power in the terminal device and transmits a message, which includes the correction amount, to the terminal device. Upon receiving the message from the base station apparatus, the terminal device adjusts the transmission power based on the correction amount contained in the message, and then transmits a message to the base station apparatus. The terminal device and the base station apparatus repeatedly perform transmitting and receiving messages until a differential amount from an ideal value of transmission timing in the terminal device falls within a predetermined range.

The base station apparatus frequency-multiplexes a plurality of terminal devices in a time slot. In order to allocate a terminal device, which is an object for handover, to a time slot, to which a terminal device has been allocated, it is necessary to adjust transmission power, and etc., without damaging the communication quality of the existing terminal device. As such, the degree of freedom for adjustment may be reduced, and performing the ranging process within a short time period is difficult. As a result, the communication quality of the existing terminal device, as well as the terminal device, which is an object for handover, may be deteriorated. Especially, this problem occurs easily when a plurality of terminal devices on a moving object, which traverses a wireless zone, are objects for handover all together. Meanwhile, a plurality of terminal devices on a moving object may be placed under a similar propagation environment, such as a relative distance from a base station apparatus, and if the terminal devices are objects for handover, performing ranging process within a short time period is possible.

Accordingly, in the base station apparatus according to an embodiment of the present invention, sub-channels included in a certain time slot are preferentially allocated to terminal devices existing in a same moving object.

As a result, when handover is performed, it is possible to perform a ranging process for terminal devices placed under a similar propagation environment, in a certain time slot, so that time required for ranging process is reduced. Accordingly, deterioration of communication quality can be prevented, and handover can be performed while maintaining a stable communication state.

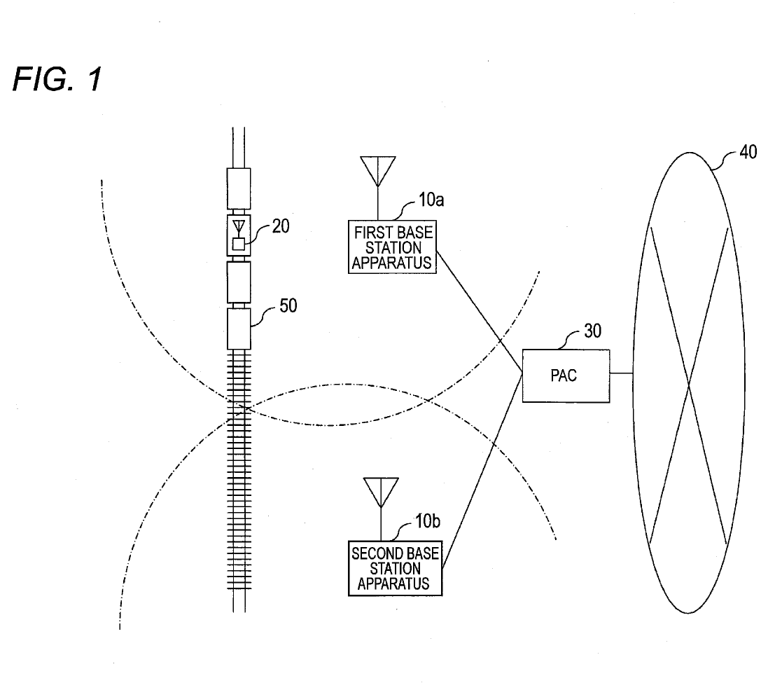

FIG. 1 is a concept view showing the configuration of a moving object communication system 1 according to an embodiment of the present invention. The moving object communication system 1 includes a first base station apparatus 10a and a second base station apparatus 10b, which are collectively referred to as a base station apparatus 10, a terminal device 20, a PAC 30, a network 40, and a moving object 50.

The base station apparatus 10 configures a wireless zone (indicated by a dash-dot line in the drawing) and performs communication with the terminal device 20 by using a predetermined wireless communication method. Herein, for the wireless communication method, a method of TDMA/TDD (Time Division Multiple Access/Time Division Duplex) system applied with OFDMA (Orthogonal Frequency Division Multiple Access) system is considered.

One end of the base station apparatus 10 is connected to the terminal device 20 through wireless communication, and the other end thereof is connected to the PAC 30 through wired communication. Here, it is assumed that the first base station apparatus 10a is a base station apparatus of a movement origin, and the second base station apparatus 10b is a base station apparatus of a movement destination.

The terminal device 20 disconnects the connection with the first base station apparatus 10a in response to a start command from either one of the terminal device 20 itself or the first base station apparatus 10a, and perform handover to establish connection with the second base station apparatus 10b.

The PAC 30 controls the base station apparatus 10 and realizes transmitting and receiving data between the terminal device 20 and a communication device, not illustrated herein, through the network 40. For example, the PAC 30 transmits data received from the network 40 and addressed to the terminal device 20, to the base station apparatus 10. Therefore, when the terminal device 20 is connected to the base station apparatus 10, the PAC 30 performs a location registration with the terminal device 20. When the terminal device 20 performs handover from the first base station apparatus 10a to the second base station apparatus 10b, the PAC 30 performs terminal connection change with the base station apparatus 10.

One end of the network 40 is connected to the PAC 30, and the other end thereof is connected to a communication device, not illustrated herein. For the network 40, for example, a network through a TCP/IP (Transmission Control Protocol/Internet Protocol) method is considered.

The moving object 50 transports the terminal device 20. For the moving object 50, for example, a train is considered. Hereinafter, for explanation convenience, if the terminal device 20 exists in one train, it is assumed that the terminal device 20 exist in one moving object.

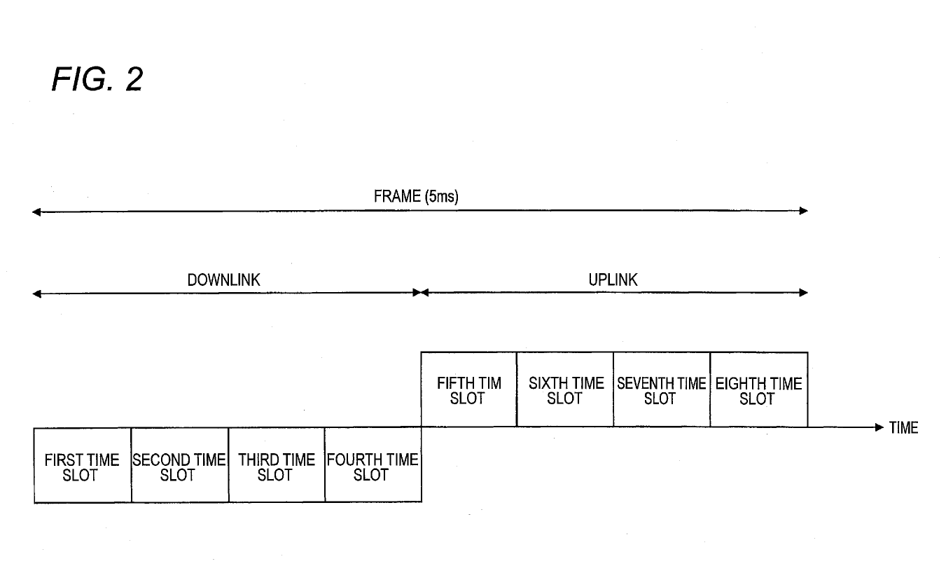

FIG. 2 is a concept view showing the frame configuration of TDMA/TDD system in a wireless communication method of the moving object communication system 1. As illustrated in FIG. 2, a TDMA frame (hereinafter “frame”) is configured by four time slots for uplink communication (from the terminal device 20 to the base station apparatus 10) and four time slots for downlink communication (from the base station apparatus 10 to the terminal device 20). In addition, frames are continuously arranged. In an embodiment of the present invention, since uplink communication and downlink communication are symmetric, hereinafter, for explanation convenience, only uplink communication or downlink communication will be described. However, the description is identically applied to the other one.

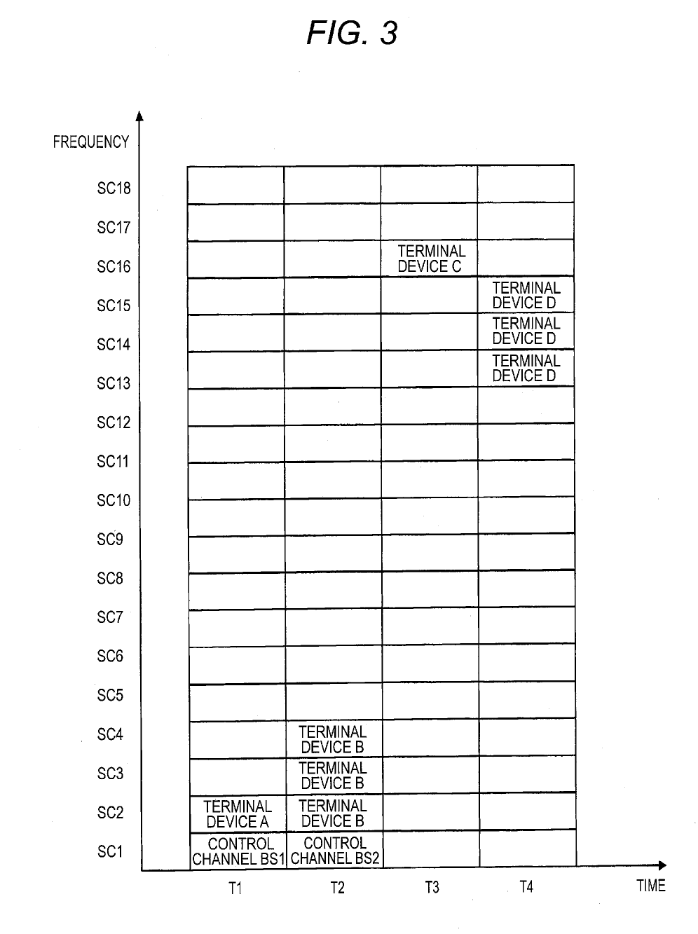

In a wireless communication method of the moving object communication system 1, as illustrated in FIG. 3, OFDMA also is applied, and a plurality of terminal devices 20 are allocated to one time slot. In FIG. 3, the horizontal axis direction shows arrangement of time slots on a time axis, and the vertical axis direction shows arrangement of sub-channels on a frequency axis. In other words, the multiplexing in the horizontal axis corresponds to TDMA, and the multiplexing in the vertical axis corresponds to OFDMA. In FIG. 3, one frame includes a first time slot (“T1” in the drawing) to a fourth time slot (“T4” in the drawing). In addition, in FIG. 3, each time slot includes a first sub-channel (“SC1” in the drawing) to an eighteenth sub-channel (“SC18” in the drawing). In FIG. 3, “terminal device A” is allocated to the second sub-channel of the first time slot, “terminal device B” is allocated to the second sub-channel to the fourth sub-channel of the second time slot, “terminal device C” is allocated to the sixteenth sub-channel of the third time slot, and “terminal device D” is allocated to the thirteenth sub-channel to the fifteenth sub-channel of the fourth time slot. It is noted that in FIG. 3, the first sub-channel is secured as a sub-channel only for a control channel. In the drawing, the first base station apparatus 10a allocates “control channel BS1” to the first sub-channel of the first time slot, and the second base station apparatus 10b allocates “control channel BS2” to the first sub-channel of the second time slot.

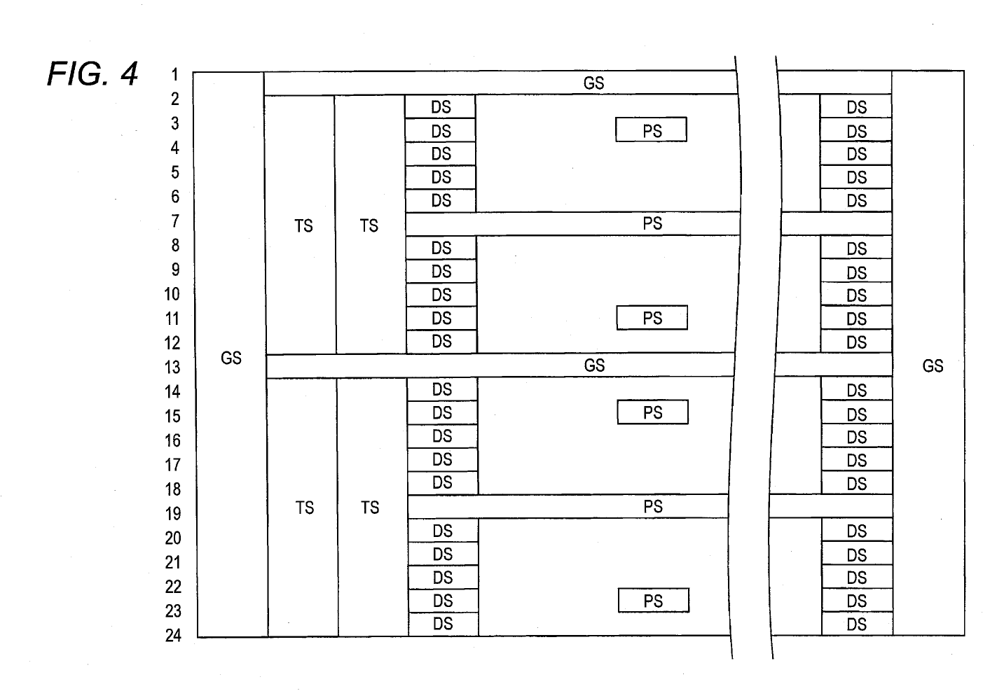

FIG. 4 is a concept view showing the configuration of a sub-channel block specified by one time slot and one sub-channel of FIG. 3. In FIG. 3, the horizontal direction shows a time axis, and the vertical direction shows a frequency axis. The numerals, “1” to “24” are numbers of sub-carriers. That is, a sub-channel is configured by OFDM multi-carrier signals. In the drawing, “TS” is a training symbol, which includes known signals, such as a symbol for synchronization detection and a symbol for estimation of a characteristic of a transmission channel. “GS” is a guard symbol, in which no effective signal is provided. “PS” is a pilot symbol, which is configured by known signals. “DS” is a data symbol, namely, refers to data to be transmitted.

The base station apparatus 10 and the terminal device 20 form a control channel by using a sub-channel block and establish a communication channel for transmitting and receiving data by transmitting and receiving a predetermined control message. For example, the base station apparatus 10 forms a logical control channel (“LCCH”), which is configured by a notification channel (hereinafter “BCCH”) for notifying start of system information, an incoming call information channel (hereinafter “PCH”) for notifying an incoming call in the terminal device 20, and a channel allocation control channel (hereinafter “SCCH”) for notifying channels allocated to the terminal device 20, and occasionally transmits it to the terminal device 20 by means of an exclusive sub-channel block. The terminal device 20 receives a control message of “BCCH” occasionally transmitted by the base station apparatus 10b to perceive the base station apparatus 10b.

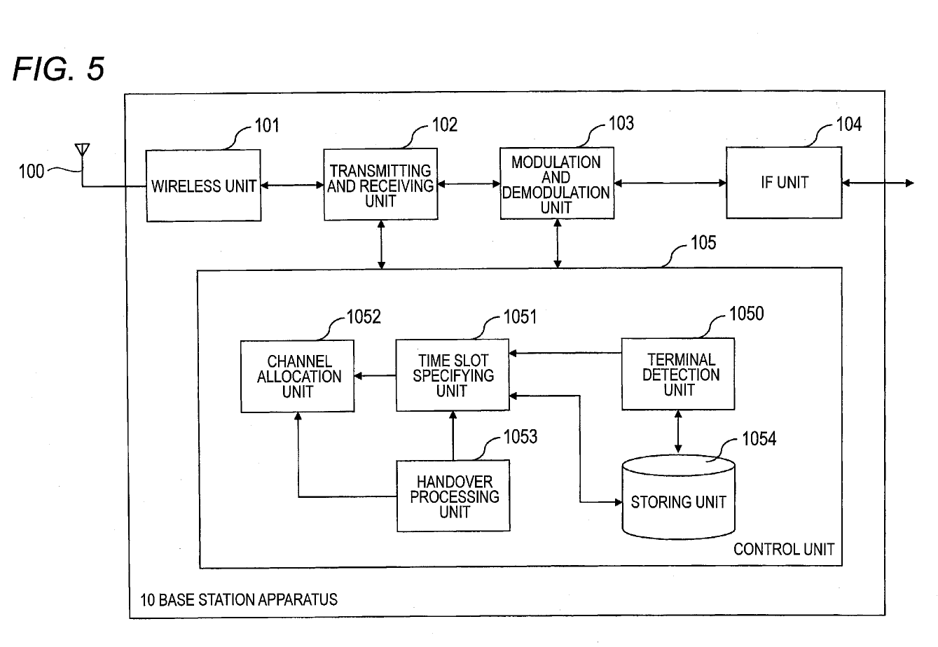

FIG. 5 is a concept view showing the configuration of the base station apparatus 10. In FIG. 5, an antenna 100 transmits and receives a signal of wireless frequency.

As a transmitting operation, the wireless unit 101 frequency-converts a baseband signal from the transmitting and receiving unit 102 to obtain a multi-carrier signal of wireless frequency. In addition, as a receiving performance, the wireless unit 101 frequency-converts the multi-carrier signal of wireless frequency received in the antenna 100 to obtain a baseband signal and outputs it to the transmitting and receiving unit 102. The baseband signal is formed with an in-phase component and a quadrature-phase component. However, for simplification of explanation, FIG. 5 illustrates only one signal line. The wireless unit 101 includes an AGC (Auto Gain Control) or an A/D (Analog/Digital) conversion unit.

As a transmitting operation, the transmitting and receiving unit 102 forms a multi-carrier signal of a frequency domain by allocating a frequency domain signal transmitted from the modulation and demodulation unit 103 to a plurality of sub-channels, and converts it into a time domain signal to output it to the wireless unit 101. In addition, for the conversion from the frequency domain signal into the time domain signal, IFFT (Inversed Fast Fourier Transform) is employed.

As a receiving operation, the transmitting and receiving unit 102 converts the time domain signal transmitted from the wireless unit 101 into a multi-carrier signal of a frequency domain, and divides it into a frequency domain signal per sub-carrier to output it to the modulation and demodulation unit 103. In addition, for the conversion from the time domain signal into the multi-carrier signal of the frequency domain, FFT (Fast Fourier Transform) is employed.

As a transmitting operation, the modulation and demodulation unit 103 modulates a signal inputted from the IF unit 104. For the modulation method, BPSK (Binary Phase Shift Keying), QPSK (Quadrature Phase Shift Keying), 16QAM (Quadrature Amplitude Modulation), 64QAM, and 256QAM, etc., are employed. As a receiving operation, the modulation and demodulation unit 103 demodulates the signal of the frequency domain transmitted from the transmitting and receiving unit 102 and outputs it to the IF unit 104.

As a receiving operation, the IF unit 104 outputs the signal demodulated in the modulation and demodulation unit 103 to the PAC 30. As a transmitting operation, the IF unit 104 outputs the signal inputted from the PAC 30 to the modulation and demodulation unit 103.

The control unit 105 performs control of timing of the entire base station apparatus 10. The control unit 105 includes a terminal detection unit 1050, a time slot specifying unit 1051, a channel allocation unit 1052, a handover processing unit 1053, and a recording unit 1054, and performs handover with the terminal device 20.

The terminal detection unit 1050 acquires location information of the terminal device 20 and calculates relative distance from the base station apparatus 10 to the terminal device 20. In order to calculate relative distance to the terminal device 20, for example, the terminal detection unit 1050 records its location information in the recording unit 1054 and obtains a difference from acquired location information of the terminal device 20.

The terminal detection unit 1050 acquires location information of the terminal device 20 at every predetermined time and calculates a movement direction and a movement distance of the terminal device 20 based on the variation.

The location information of the terminal device 20 may be acquired directly from the terminal device 20 if the terminal device 20 has GPS (Global Positioning System). Alternatively, the location information of the terminal device 20 may be estimated by prerecording a table for defining the correspondence between propagation distance and propagation loss in the recording unit 1054, acquiring information about transmission power of a known signal from the terminal device 20, measuring receiving power when the known signal is received, and referencing the table.

The terminal detection unit 1050 detects a terminal device 20 existing in the moving object 50 by using relative distance to the terminal device 20, a movement speed of the terminal device 20, and a movement direction of the terminal device 20 as determination factors.

The terminal detection unit 1050 may detect the terminal device 20 existing in the moving object 50 by using location of the terminal device 20 as a determination factor. And, the terminal detection unit 1050 forms a set (hereinafter a “moving object group”) including a plurality of terminal devices 20 which are determined to exist in one moving object. In order to form moving object groups, the terminal detection unit 1050 performs group classification of the terminal device 20 based on the determination factor.

Accordingly, the terminal detection unit 1050 first confirms whether the terminal device 20 can be classified into an existing moving object group. Here, each moving object group is associated with three values (hereinafter “property values”) including a relative distance to the terminal device 20 belonging to the group, a movement speed of the terminal device 20 belonging to the group, and a movement direction of the terminal device 20 belonging to the group.

The terminal detection unit 1050 compares values of the determination factors of a terminal device 20 and property values of the existing moving object group. If differences between values of all the determination factors and property values of the existing moving object group are within certain ranges, respectively, the terminal detection unit 1050 classifies the terminal device 20 into the existing moving object group.

If the terminal devices 20 can not be classified into any existing moving object group, the terminal detection unit 1050 forms a new moving object group and classifies the terminal device 20 therein. In this case, the values of the determination factors of the classified terminal device 20 are kept in association with property values of the new moving object group.

By performing these process, the terminal detection unit 1050 forms a moving object group, which is a set of a plurality of terminal devices 20 existing in one moving object.

Comparison of values of the determination factors may be performed by setting a priority to a relative distance to the terminal device 20, a movement speed of the terminal device 20, and a movement direction of the terminal devices 20, in this order, such that the comparison is performed first for the determination factor having the highest priority. This is because group classification of the terminal device 20 can be effectively performed.

In addition, property values of a moving object group may be updated by measuring a relative distance, a movement speed, and a movement direction of each terminal device 20 belonging to the moving object group at a predetermined cycle and averaging them, respectively. This is because, even if the movement state of a moving object changes from the time when the moving object group has been formed, it is possible to classify the terminal device 20 existing in the moving object into an appropriate moving object group.

Furthermore, the process of classifying the terminal device 20 into a moving object group may not be performed if the movement speed of the terminal device 20 is smaller than a predetermined threshold value. This is because the terminal device 20, which does not exist in the moving object, are not objects for the process. As a result, process efficiency is improved.

The time slot specifying unit 1051 specifies a time slot to allocate a sub-channel block to the terminal device 20. Especially, a time slot is specified such that a certain time slot is preferentially allocated to the terminal device 20 existing in one moving object. Accordingly, the time slot specifying unit 1051 records a table for associating a moving object group and a time slot in the recording unit 1054. With reference to the table, for a terminal device 20 which has been classified into a moving object group by the terminal detection unit 1050, a time slot corresponding to the moving object group is specified. Accordingly, for the terminal device 20 existing in one moving object, a time slot corresponding to the moving object can be preferentially allocated.

It is noted that association between a moving object group and a time slot is performed for a predetermined maximum number of slots (for example, “2”) and is not performed for slots exceeding the number. Here, the maximum number of slots is preferably less than half of the number of time slots configuring a frame. This is because securing a time slot to associate a moving object group thereto becomes easy. In addition, different time slots are associated with a plurality of moving object groups, respectively.

The time slot specifying unit 1051 associates a moving object group and a time slot in the second base station apparatus 10b, based on the use status of time slots in the first base station apparatus 10a. As a result, it is easy to collectively perform handover a plurality of terminal devices 20 in a moving object group, i.e., the terminal device 20 existing in one moving object, in the unit of time slot. In addition, overlapping use of time slots can be reduced, and deterioration of communication quality can be prevented.

For the above, the time slot specifying unit 1051 acquires information about the use status of time slots from the first base station apparatus 10a through the handover processing unit 1053. And, with reference to the information about the use status of time slots, the time slot specifying unit 1051 associates a moving object group with a time slot in the second base station apparatus 10b without overlapping with a time slot which the first base station apparatus 10a has associated with a moving object group.

The time slot specifying unit 1051 specifies a time slot, which is not associated to a moving object group and has an empty sub-channel block, for another terminal device 20, i.e., a terminal device 20 which does not belong to any moving object group, or a terminal device 20 which belongs to a moving object group, which is not associated with any time slot.

The channel allocation unit 1052 allocates an empty sub-channel block included in the time slot specified by the time slot specifying unit 1051 to the terminal device 20. The allocation of the sub-channel block is performed in response to a new or additional wireless resource acquisition request, or the like, from the terminal device 20. Here, a new wireless resource acquisition request is generated, for example, in the case where the terminal device 20 starts communication or the terminal device 20 hands over from the first base station apparatus 10a to the second base station apparatus 10b during communication.

The handover processing unit 1053 performs handover process with the terminal device 20. That is, the handover processing unit 1053 monitors communication state between the first base station apparatus 10a and the terminal device 20. If it is determined that communication state is deteriorated, the handover processing unit 1053 determines performing handover. For example, if RSSI (Received Signal Strength Indication) of a signal received from the terminal device 20 is smaller than a predetermined threshold value, or the number of errors detected through CRC (Cyclic Redundancy Check) is larger than a predetermined threshold value, the handover processing unit 1053 determines that communication state is deteriorated.

The handover processing unit 1053 performs disconnection process between the first base station apparatus 10a and the terminal device 20. As the disconnection process, for example, a command is sent to the channel allocation unit 1052 to release a sub-channel block allocated to the terminal device 20.

The handover processing unit 1053 performs connection process between the second base station apparatus 10b and the terminal device 20. As the connection process, for example, a command is sent to a ranging processing unit, not illustrated herein, to perform adjustment of transmission power, and etc., with the terminal device 20. Furthermore, a command is sent to the time slot specifying unit 1051 and the channel allocation unit 1052 to allocate a sub-channel block to the terminal device 20 which has requested handover.

In this case, as described above, the handover processing unit 1053 controls the time slot specifying unit 1051 to prevent the first base station apparatus 10a and the second base station apparatus 10b from associating a moving object group to an overlapping time slot.

That is, the handover processing unit 1053 acquires information about the use status of time slots from the first base station apparatus 10a. Information about the use state of time slots may be acquired from the first base station apparatus 10a, for example, through the PAC 30 or may be transmitted from the first base station apparatus 10a to the terminal device 20, and then acquired from the terminal device 20 when performing handover.

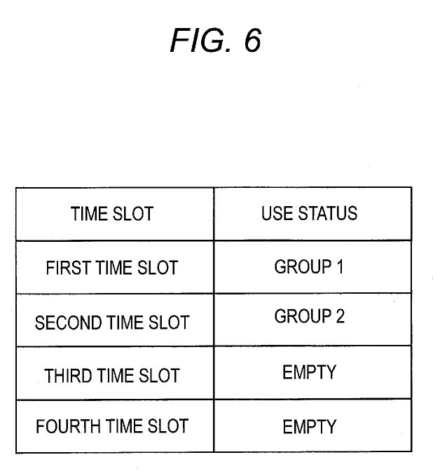

The recording unit 1054 records a table, and etc., which is referenced by the time slot specifying unit 1051 to specify time slots. FIG. 6 is a concept view showing a data structure of the table for associating a moving object group and a time slot, which is recorded by the recording unit 1054. As illustrated, the table includes a time slot column and a use status column. In the time slot column, identification information of time slots configuring a frame is stored. In the use status column, identification information of moving object groups associated to time slots is stored. In FIG. 6, “Moving Object Group 1” is associated with a “First Time Slot,” and “Moving Object Group 2” is associated with a “Second Time Slot.” As illustrated in FIG. 2, since the number of time slots configuring one frame is “4,” the maximum number of slots is “2.” Accordingly, even if “Moving Object Group 3” exists, the time slot specifying unit 1051 does not associate it to a “Third Time Slot” or a “Fourth Time Slot.”

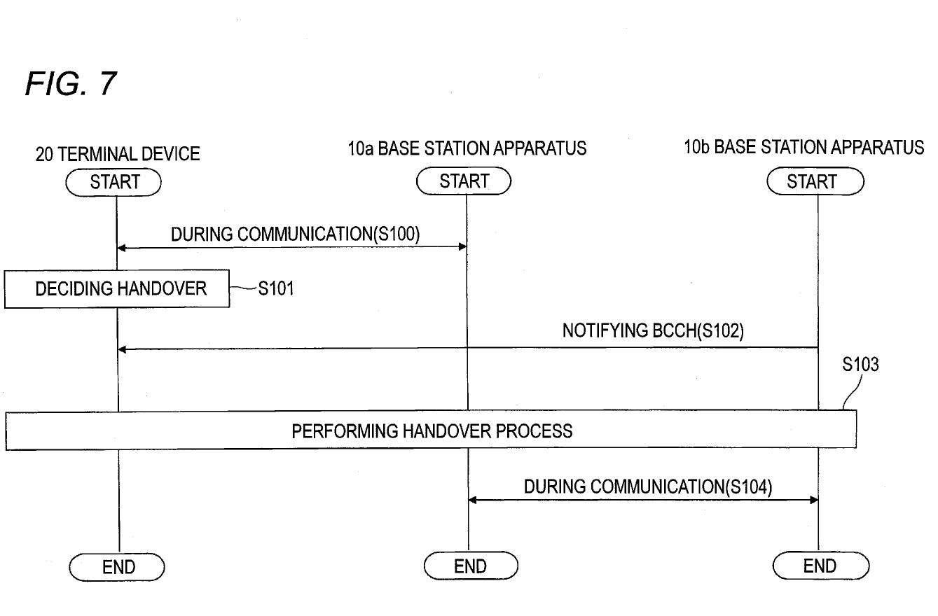

The operation of the moving object communication system 1 according to the above configuration will be described. FIG. 7 is a sequence view showing the handover procedure when the terminal device 20 hands over from the first base station apparatus 10a to the second base station apparatus 10b. During communication with the first base station apparatus 10a (S100), if RSSI of a received signal becomes lower than a predetermined threshold value, the terminal device 20 decides handover (S101). The terminal device 20 receives a control message of “BCCH” notified from the second base station apparatus 10b to perceive the second base station apparatus 10b. The terminal device 20 perform handover from the first base station apparatus 10a to the second base station apparatus 10b (S103), and establish a communication channel with the second base station apparatus 10b (S104).

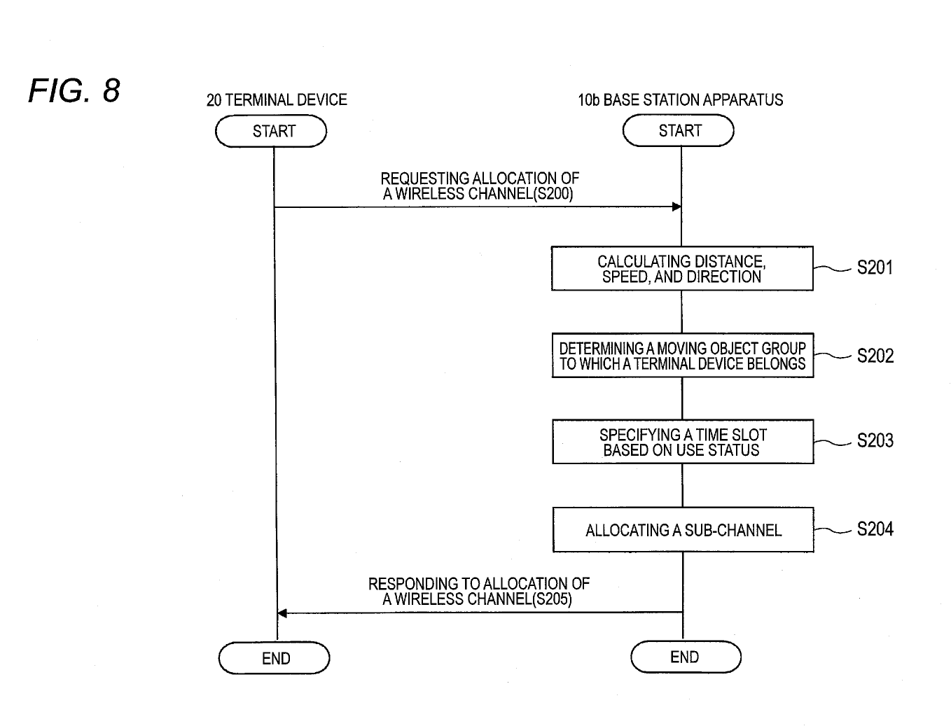

FIG. 8 is a sequence view showing the connection procedure to establish a communication channel with the second base station apparatus 10b. The terminal device 20 requests allocation of a wireless channel in the process of handover to the second base station apparatus 10b (S200). The second base station apparatus 10b calculates a relative distance to the terminal device 20, a movement speed of the terminal device 20, and movement direction of the terminal device 20 (S201). Based on these determination factors, the terminal device 20 is classified into a moving object group, to which the terminal device 30 should belong (S202). Based on information about the use status of time slots acquired from the first base station apparatus 10a, the second base station apparatus 10b specifies a time slot to allocate a wireless channel to the terminal device 20 (S203). And, an empty sub-channel block included in the specified time slot is allocated to the terminal device 20 (S204), and allocation of a communication channel is responded to the terminal device 20 (S205).

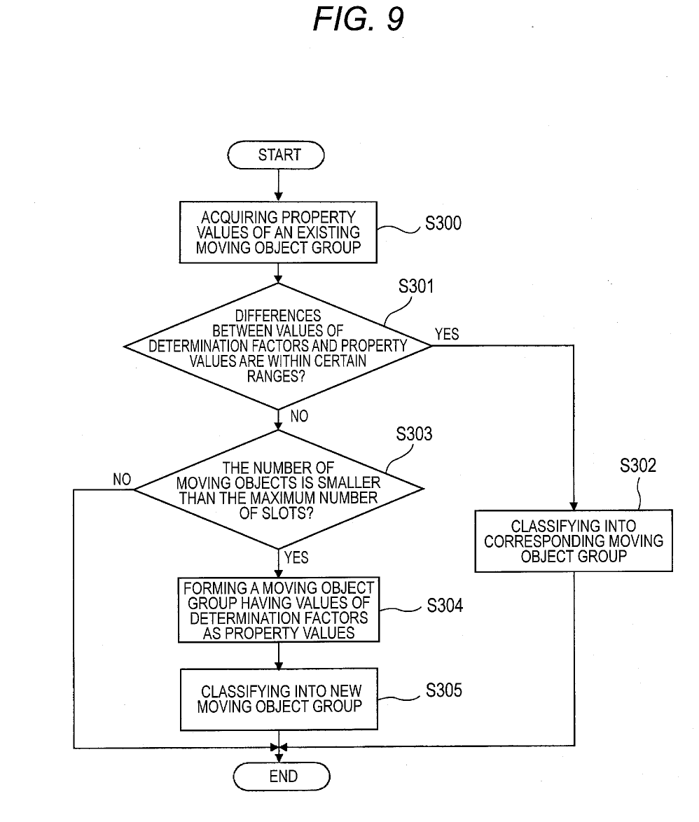

FIG. 9 is a flow chart showing the procedure of classification of the terminal device 20 into the moving object groups. The terminal detection unit 1050 acquires property values of an existing moving object group (S300). The property values are compared with values of the determination factors of the terminal device 20, which is an object, and it is confirmed whether differences in the values are within certain ranges, respectively (S301). If there are property values having differences from determination factors within certain ranges, respectively (Y of S301), the terminal device 20 is classified into a moving object group, which is associated with the property values (S302). If there are no property values having differences from determination factors within certain ranges (N of S302), the total number of existing moving object groups is compared with the maximum number of slots (S303). If the total number of existing moving object groups is smaller than the maximum number of slots (Y of S303), a new moving object group having values of the determination factors as property values is formed (S304), and the terminal devices (20) are classified thereinto (S305). If the total number of existing moving object groups is larger than the maximum number of slots (N of S303), classification into moving object groups is not performed.

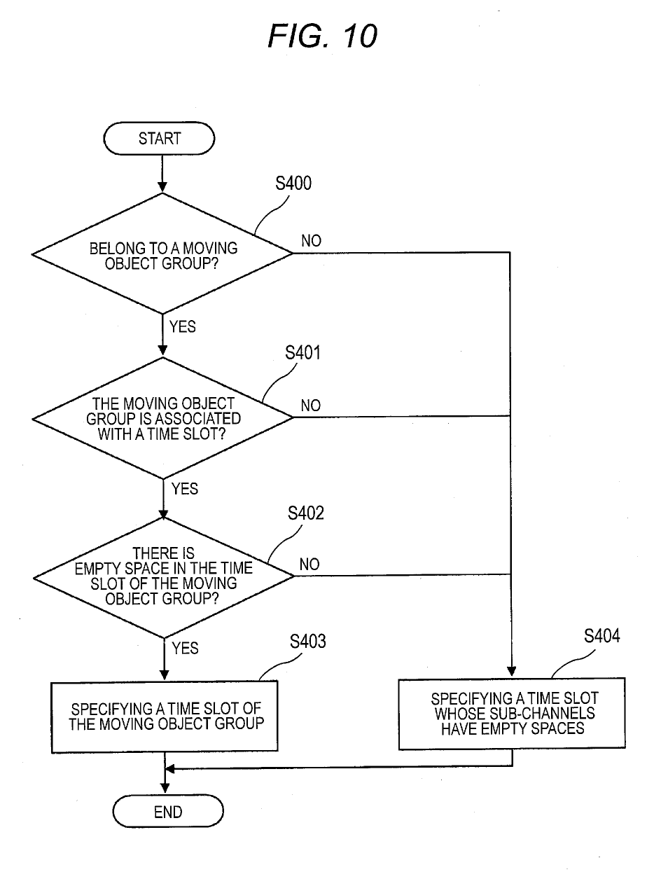

FIG. 10 is a flow chart showing the procedure of specifying a time slot. The time slot specifying unit 1051 confirms whether the terminal device 20, which is an object, belongs to any moving object group (S400). If the terminal device 20 belongs to a moving object group (Y of S400), the time slot specifying unit 1051 confirms whether the moving object group is associated with a time slot, with reference to the table illustrated in FIG. 6 (S401). If the moving object group is associated with a time slot (Y of S401), it is confirmed whether there is an empty sub-channel block in the associated time slot (S402). If there is an empty sub-channel block (Y of S402), the time slot is specified as a time slot to allocate a wireless channel to the terminal device 20, which is an object (S403). If the terminal device 20, which is an object, dose not belong to any moving object group (N of S400), the moving object group is not associated with a time slot (N of S401), or there is no empty space in the associated time slot (N of S402), a time slot, which is not associated with any moving object group and which has an empty sub-channel block, is specified (S404).

According to an embodiment of the present invention, the advantageous effects set forth below can be achieved.

(1) The terminal detection unit 1050 classifies the terminal device 20 into a predetermined moving object group based on determination factors. The time slot specifying unit 1051 associates the moving object group to a time slot and specifies the associated time slot for the terminal device 20 of the moving object group. The channel allocation unit 1052 allocates a sub-channel block included in the time slot specified by the time slot specifying unit 1051 to the terminal device 20 of the moving object group. As a result, the terminal device 20 existing in one moving object is allocated to a specified time slot, so that a difference of transmission power or transmission timing, which should be adjusted, between a plurality of terminal devices 20 allocated to the time slot can be reduced, and thereby reducing time required for ranging process. In addition, deterioration of communication quality can be prevented, and handover can be performed while maintaining a stable communication state.

(2) In addition, the handover processing unit 1053 acquires information about the use status of time slots from the first base station apparatus 10a, and controls the time slot specifying unit 1051 such that the second base station 10b associates a moving object group and a time slot without overlapping with a time slot, to which the first base station apparatus 10a associates a moving object group. As a result, it is easy to collectively perform handover a plurality of terminal devices 20 existing in one moving object in the unit of time slots. In addition, overlapping use of time slots can be reduced, and deterioration of communication quality can be prevented.

(3) In addition, the terminal detection unit 1050 performs classification into a moving object group by using a relative distance to the terminal device 20, a movement speed of the terminal device 20, and a movement direction of the terminal device 20 as determination factors. Accordingly, it is possible to surely classify the terminal device 20 existing in one moving object into the corresponding moving object group.

(4) In addition, the terminal detection unit 1050 sets a priority to the relative distance to the terminal device 20, the movement speed of the terminal device 20, and the movement direction of the terminal devices 20 in this order, such that comparison is performed from the determination factor having the highest priority with property values of an existing moving group. As a result, effective classification is possible.

The best mode to carry out the present invention has been described. However, the present invention is not limited to the configuration of the above embodiment, and various modifications, which are within the application scope of the present invention defined in the claims and can achieve the functions according to the configuration in the embodiment that has been described, are possible.

An embodiment of the present invention describes, for example, that if the terminal device 20 exist in one train, it is assumed that the terminal device 20 exist in one moving object. However, the present invention is not limited thereto, and whether the terminal device 20 exists in one moving object may be determined based on each train car constituting of a train, or if a plurality of satellite stations are mounted in a train, whether the terminal device 20 exist in one moving object may be determined based on each satellite station.

The present application is based on the Japanese Patent Application No. 2008-084904 filed on Mar. 27, 2008, the disclosures of which are hereby incorporated by reference.

1. A base station apparatus comprising:
a detection unit which detects a terminal device existing in a moving object; and
an allocation unit which, if the detection unit detects a plurality of terminal devices in the moving object, allocates a sub-channel being frequency-multiplexed in a certain time slot, to the plurality of the terminal devices.

2. The base station apparatus according to claim 1,
wherein the allocation unit specifies a time slot for each of a plurality of moving objects, and allocates, to a plurality of terminal devices existing in a same moving object, sub-channels included in the time slot specified for the moving object.

3. The base station apparatus according to claim 1, further comprising:
a search unit which searches a use status of time slots in another base station apparatus; and
a performing unit which performs a handover process with a plurality of terminal devices existing in a same moving object,
where when allocating sub-channels to the plurality of terminal devices in the handover process, the performing unit controls the allocation unit to specify a time slot, which is less used in a handover originating base station apparatus, for the plurality of terminal devices, based on the use status searched by the search unit.

4. The base station apparatus according to claim 1,
wherein in order to detect a terminal device existing in a moving object, the detection unit uses a relative distance to the terminal device, a movement speed of the terminal device, and a movement direction of the terminal device, as determination factors.

5. The base station apparatus according to claim 4,
wherein the detection unit sets a priority to the relative distance to the terminal device, the movement speed of the terminal device, and the movement direction of the terminal device, in this order, and detects the terminal device with reference to the determination factors based on the priority.

6. The base station apparatus according to claim 1,
wherein if the movement speed of the terminal device is smaller than a predetermined threshold value, the detection unit does not perform the detection.

7. The base station apparatus according to claim 1,
wherein in order to detect a terminal device existing in a moving object, the detection unit uses a location of the terminal device as a determination factor.

8. A base station apparatus comprising:
an acquisition unit which acquires information, the information being based on locations of a plurality of terminal devices;
a group forming unit which forms a moving object group including a plurality of terminal devices based on the acquired information; and
an allocation unit which allocates a plurality of sub-channel being frequency multiplexed in a certain time slot to the plurality of terminal devices belonging to the moving object group.

9. The base station apparatus according to claim 8, further comprising:
a storing unit which stores a table for associating a moving object group formed in the group forming unit and a time slot,
wherein the allocation unit allocates a plurality of sub-channels in the time slot associated with the moving object group in the table.

10. The base station apparatus according to claim 9,
wherein the group forming unit forms a plurality of moving object groups, and
wherein the table associates different time slots to the plurality of moving object groups, respectively.

11. The base station apparatus according to claim 8,
wherein the moving object group is associated with a property value related to a terminal device belonging to the moving object group, and
wherein if the acquisition unit acquires information based on a location of a terminal device, the group forming unit compares the acquired information with the property value to determine whether the corresponding terminal device is to belong to the moving object group.

12. The base station apparatus according to claim 11,
wherein the property value is obtained based on the information acquired by the acquisition unit, the information being based on locations of the plurality of terminal devices belonging to the moving object group.

13. The base station apparatus according to claim 8,
wherein the information based on the locations includes a relative distance of the terminal device to the base station apparatus, a movement speed of the terminal device, and a movement direction of the terminal device.
